(19) United States
(12) Patent Application Publication
(10) Pub. No.: US 2014/0156313 A1
(43) Pub. Date: Jun. 5, 2014

(54) SYSTEM AND METHOD FOR USING INSURANCE PICTORICAL CLASSIFICATION

(71) Applicant: HARTFORD FIRE INSURANCE COMPANY, Hartford, CT (US)

(72) Inventors: James S. Rogers, Willington, CT (US); Jon C. Desjardins, Hebron, CT (US); Derrick Joseph Karle, Wallingford, CT (US); Steven Anthony Simone, Helotes, TX (US)

(73) Assignee: HARTFORD FIRE INSURANCE COMPANY, Hartford, CT (US)

(21) Appl. No.: 13/692,566

(22) Filed: Dec. 3, 2012

(51) Int. Cl. G06Q 40/08

(52) U.S. Cl. CPC G06Q 40/08
USPC 705/4

(57) ABSTRACT

A display device may display to a user questions related to insurance products. The user may be a business owner, and the questions may solicit information that may be used to determine which of the insurance products are applicable to the user's business. Input data may be received from a user that is responsive to the questions. The input data may indicate, for example, the type of industry of the business and the location of the business. Next, the display device may present the user with a set of pictures that are related to the user's business industry. Input data may be received from the user, selecting a subset of the pictures. Based on the input data, a business classification may be determined. The business classification along with underwriting information may be used to determine a business insurance product and options that are applicable to the business.

### TECHNICAL FIELD

The subject matter disclosed herein relates to computer systems and data communication systems. More particularly, the subject matter disclosed herein relates to the electronic storage, communication, processing, and display of data related to business insurance and other insurance products.

### BACKGROUND

Insurance consumers benefit from insurance products such as property insurance, liability insurance, workers' compensation insurance, and other insurance products. To streamline and create a more consistent underwriting process, insurance carriers categorize businesses and liabilities according to codes. Accordingly, each business may be categorized by one or more liability classification codes. During the underwriting process, an agent may solicit answers to questions, determine which codes apply to a business and therefore determine an overall assessment of the business to determine potential exposure.

Insurance consumers may be confused by the classification codes or not even not aware of them. This may lead to the consumer not being aware of which insurance products are applicable to them, or which products may best meet their insurance needs therefore they may not be able to effectively communicate to the insurance agent their insurance needs. Therefore, new technologies are required that may be used by insurance consumers to provide information to the insurance agent so that agent can create a more accurate business classification to generate a risk profile from which to provide a more accurate quote and to determine which insurance products are applicable to them and best meet their insurance needs.

### SUMMARY

A system for the processing and displaying of information related to business insurance products offered by an insurance company. The system allows a potential insured or an agent to describe or classify their industry and the business they perform using a combination of a “palette,” pictures, metadata and the insured's address to correctly classify the business. The system may include a memory device that stores pictures related to business insurance products, metadata associated with the pictures, and information related to a plurality of business insurance products. The system may also include a user display device configured to display information to a user that indicates questions related to general information about the business. The system may include an input interface to receive input data from the user that is responsive to the questions. The system may also include a processor to determine a set of pictures from the memory device based on the input data. The user display device may display sets of pictures and the input interface may receive input data from the user that selects a subset of the pictures that are relevant to the user's business. The processor may be further configured to determine, based on metadata associated with the selected subset of pictures, a business classification and risk profile. Based on the business classification and risk profile, the processor may determine a list of underwriting questions to present on the user display device. The processor may further be configured to identify a business insurance product and multiple options to offer the user based on the response to the underwriting questions and the business classification and risk profile.

### BRIEF DESCRIPTION OF THE DRAWINGS

A more detailed understanding may be had from the following description, given by way of example in conjunction with the accompanying drawings wherein:

FIG. 1 shows an example architecture for communicating, displaying, and processing data related to insurance products;

FIG. 2 shows an example web page that includes one or more questions that solicit information from a business owner related to their business;

FIGS. 3A-3C show example web pages that include picture selections for business classification;

FIG. 4A shows an example a business classification results web page;

FIG. 4B shows an example web page that includes one or more questions that solicit additional underwriting information from a business owner related to their business;

FIGS. 5-7 show example web pages for different industries that include picture selections for business classification;

FIG. 8 shows an example method for pictorial classification of a business;

FIG. 9 shows an example computing device that may be used to implement features described herein with reference to FIGS. 1-8; and

FIG. 10 shows an example cellular phone that may be used to implemented features described herein with reference to FIGS. 1-9.

### DETAILED DESCRIPTION

During the underwriting process, proper business classification is important to generate an accurate assessment of exposures and liabilities associated with a business. Methods and apparatus are described in greater detail hereafter for providing a user with a picture based method to categorize their business and to categorize the types of perils for which they seek coverage. Each picture includes metadata that is associated with it. When a user selects a picture, a web site system analyzes the metadata to determine a business classification and risk profile along with a set of underwriting questions related to the user's business. The user's response to the underwriting questions along with the metadata associated with the picture selections is used to generate an assessment of the exposure and liability associated with the business. And, if the business classification and risk are acceptable, the website may generate a quote to present to the business owner.

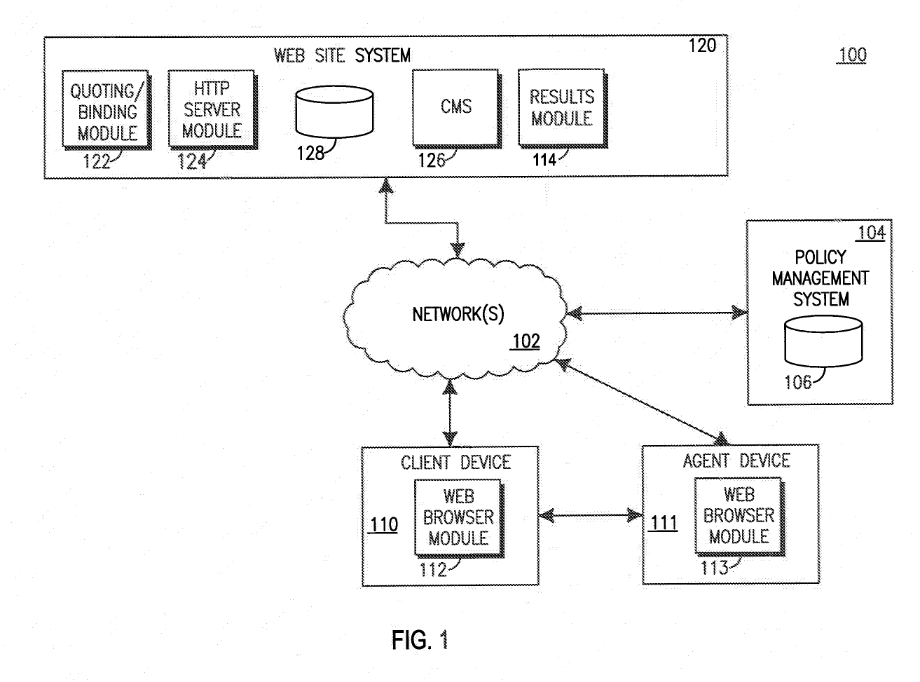

FIG. 1 shows an example architecture 100 for communicating, displaying, and processing data related to business insurance products. The example architecture 100 includes a web site system 120, and multiple user devices (a client device 110 and agent device 111), a policy management system 104, and one or more communication networks 102. The web site system 120 may provide access to a web site that is managed by an insurance company. A user device may access the web site via the one or more communication networks 102, and display the web site to a user of the client device 110 or agent device 111. The user may be, for example, a business owner or an insurance agent. Alternatively, a business owner may use a client device 110 to access an agent device 111 which in turn is able to access protected features of the web site system 120. The web site may include a page that includes questions of one or more types. As an example, questions of a first type may solicit information regarding attributes of the user's business, while questions of a second type may solicit information related to a user's goals and/or needs and/or dangers with respect to business insurance. The user may provide information that is responsive to the questions, which may then be transmitted to the web site system 120 by the client device 110. The web site system 120 may then determine, based on the information provided by the user in response to the questions, the insurance products that are applicable to the user's business. The web site system 120 may then transmit additional information back to the client device 110, related to the applicable products. Using the client device 110, the user may then obtain additional information related to the applicable product options, receive a quote for applicable product options, initiate the purchase of an applicable product option (by, for example, contacting an agent or employee of the insurance company), and/or enter into a binding agreement for the purchase of an applicable product option. Similarly, the agent device 111 may access the web site system 120, a company intranet, or other online information using web browser module 113.

The web site system 120 may include a HyperText Transfer Protocol (HTTP) server module 124, a Content Management System (CMS) 126, a product quoting/binding module 122, a web site database 128, and a results module 114. The HTTP server module 124 may implement the HTTP protocol, and may communicate HyperText Markup Language (HTML) pages and related data from the web site to/from the client device 110 using HTTP. The HTTP server module 124 may be, for example, an APACHE HTTP server, a SUN-ONE Web Server, a MICROSOFT Internet Information Services (IIS) server, and/or may be based on any other appropriate HTTP server technology.

The web site database 128 may store information that describes the content of the web site. The web site database 128 may be a relational database, a hierarchical database, an object-oriented database, one or more flat files, one or more spreadsheets, and/or one or more structured files. The web site database 128 may be managed by a database management system (not depicted) in the web site system 120, which may be based on a technology such as MICROSOFT SQL Server, MYSQL, POSTGRESQL, ORACLE Relational Database Management System (RDBMS), a NOSQL database technology, and/or any other appropriate technology. In addition to the page that includes one or more questions that solicit information regarding the user's business, the web site may include one or more Electronic Books (E-Books) that provide information related to the business insurance products offered by the insurance company. Information describing the web pages and the E-Books that constitute the web site may be stored in the web site database 128.

The CMS 126 may be used by administrators of the web site to manage the content of the web site stored in the web site database 128. The CMS 126 may change the content of the web site by adding, deleting, or modifying data in the web site database 128 via the database management system. The CMS 126 may be, for example, a FATWIRE system, a DRUPAL system, a JOOMLA system, an IBM Lotus Web Content Management system, and/or may be based on any other appropriate CMS technology.

The quoting/binding module 122 may be or include one or more web applications that, in conjunction with the HTTP server module 124, the CMS 126, and/or the policy management system 104, may be used to provide one or more web pages to the client device 110 that provide a price quote for an insurance product offered by the insurance company. Alternatively or additionally, the one or more web applications, in conjunction with the HTTP server module 124, the CMS 126, and/or the policy management system 104, may be used to enter the user of the client device 110 into a binding agreement for the purchase of an insurance product via the web site.

As described above, the web site system 120 may transmit web pages to the client device 110 that may include one or more questions that solicit information regarding the user's business. This may be performed by, for example, the HTTP server module 124 in conjunction with the CMS 126 and/or the web site database 128. Also as described above, the user may provide information that is responsive to the questions, which may then be transmitted to the web site system 120 by the client device 110. The information may be received via the HTTP server module 124, which may then provide the information to the results module 114. The results module 114 may determine results information to send back to the client device 110, based on the information that is responsive to the questions. This may include, for example, determining which products are applicable to the user's business, and/or how information related to the applicable products should be displayed. The results module 114, in conjunction with the HTTP server module 124 and/or the CMS 126, may then transmit information back to the client device 110 related to the products that have been determined by the results module 114 as applicable to the user's business.

The web site system 120 may also include one or more additional components or modules (not depicted), such as one or more load balancers, firewall devices, routers, switches, and devices that handle power backup and data redundancy.

The client device 110 may include a web browser module 112, which may communicate data related to the web site to/from the HTTP server module 124 in the web site system 120 via the one or more communication networks 102. The web browser module 112 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 112 may implement Rich Internet Application (RIA) and/or multimedia technologies such as ADOBE FLASH, MICROSOFT SILVERLIGHT, and/or other technologies. The web browser module 112 may implement RIA and/or multimedia technologies using one or web browser plug-in modules (such as, for example, an ADOBE FLASH or MICROSOFT SILVERLIGHT plug-in), and/or using one or more sub-modules within the web browser module 112 itself. The web browser module 112 may display data on one or more display devices (not depicted) that are included in or connected to the client device 110, such as a liquid crystal display (LCD) display or monitor. The client device 110 may receive input from the user of the client device 110 from input devices (not depicted) that are included in or connected to the client device 110, such as a keyboard, a mouse, or a touch screen, and provide data that indicates the input to the web browser module 112. The client device 110 may be, for example, a cellular phone, a laptop computer, a tablet computer, or any other appropriate computing device.

The policy management system 104 may perform functionality such as managing information related to one or more insurance products held by the insurance company. The policy management system 104 may include a product management database 106, which may store information that describe clients of the insurance company and the policies' products provided to the clients by the insurance company. The product management database 106 may be a relational database, a hierarchical database, an object-oriented database, one or more flat files, one or more spreadsheets, and/or one or more structured files. The product management database 106 may be managed by a database management system (not depicted). When a client enters into an agreement for the purchase of a product with the insurance company, information related to the agreement may be added to the product management database 106. Alternatively or additionally, when a user of the client device 110 enters into an agreement for the purchase of a product via the quoting/binding module 122 in the web site system 120, the quoting/binding module 122 may communicate with the policy management system 104, and the product management database 106 may be updated accordingly.

The one or more communication networks 102 in the example architecture 100 may include one or more private Local Area Networks (LANs), and/or one or more public communication networks such as the Internet. The one or more communication networks 102 may be based on wired and/or wireless networking technologies.

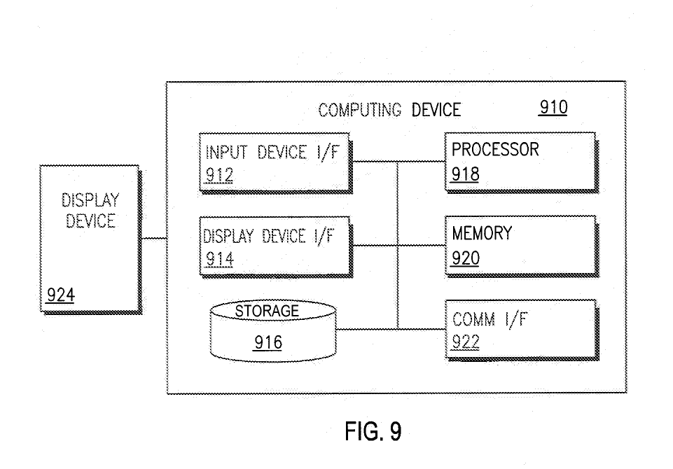

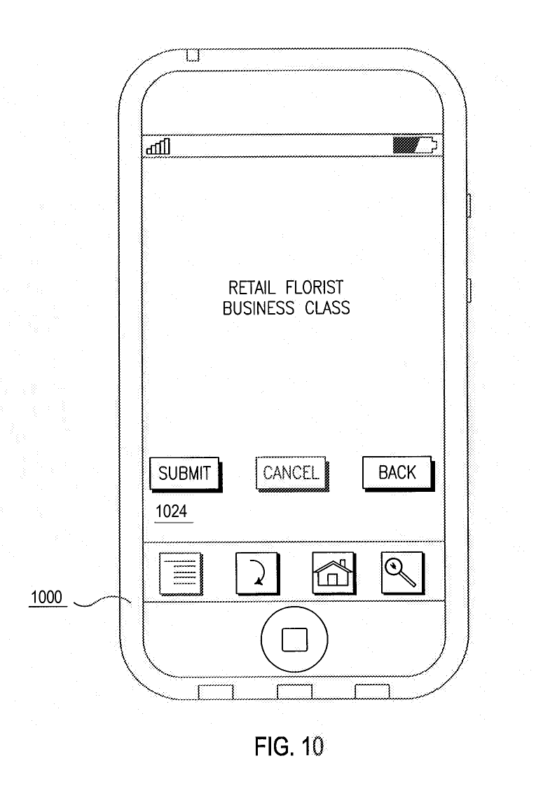

The architecture 100 of FIG. 1 may be implemented using any number of different network topologies and computing devices. For example, each of the quoting/binding module 122, HTTP service module 124, CMS 126, and results module 114 may be implemented using a single computing device, as one or more separate computing devices, or spread across any two or more computing devices, in any combination. Further, the policy management system 104 may be implemented using a single computing device, as one or more separate computing devices, or spread across any two or more computing devices. An example of a computing device that may be used for the implementation of any or any combination of these entities 122, 124, 126, 114, 104 is the computing device 910 that is described below with reference to FIG. 9. Alternatively or additionally, the client device 110 may be implemented using a computing device such as the computing device 910 that is described below with reference to FIG. 9 or the cellular phone 1000 described below with reference to FIG. 10.

The web site system 120 is configured to store images in a memory device. The images may include images related to business insurance products; this may include pictures of types of businesses, types of work performed by businesses, types of incidents requiring insurance. Each picture is linked in the database with metadata associated with that picture. The metadata is used to assist the web site system in classifying the user's business and determining the type of insurance products to recommend to the user. For example, the metadata assigned to each picture may include one or more of the following:

a. picture number or filename;

b. picture file type, (e.g. .jpeg, .gif);

c. industry (e.g. retail, manufacturing, wholesale, tech);

d. liability code associated with the industry;

e. worker's compensation codes associated with the activity/industry;

f. commercial automobile codes;

g. underwriting/class questions;

h. corporate appetite for coverage of industry/activity; and/or

i. suggested/recommended coverages.

In another embodiment, if the user of the client device 110 has transmitted pictures for uploading to the website system 120, the metadata may include the time the picture was taken, the GPS or other location coordinates where the picture was taken, and other location based metadata.

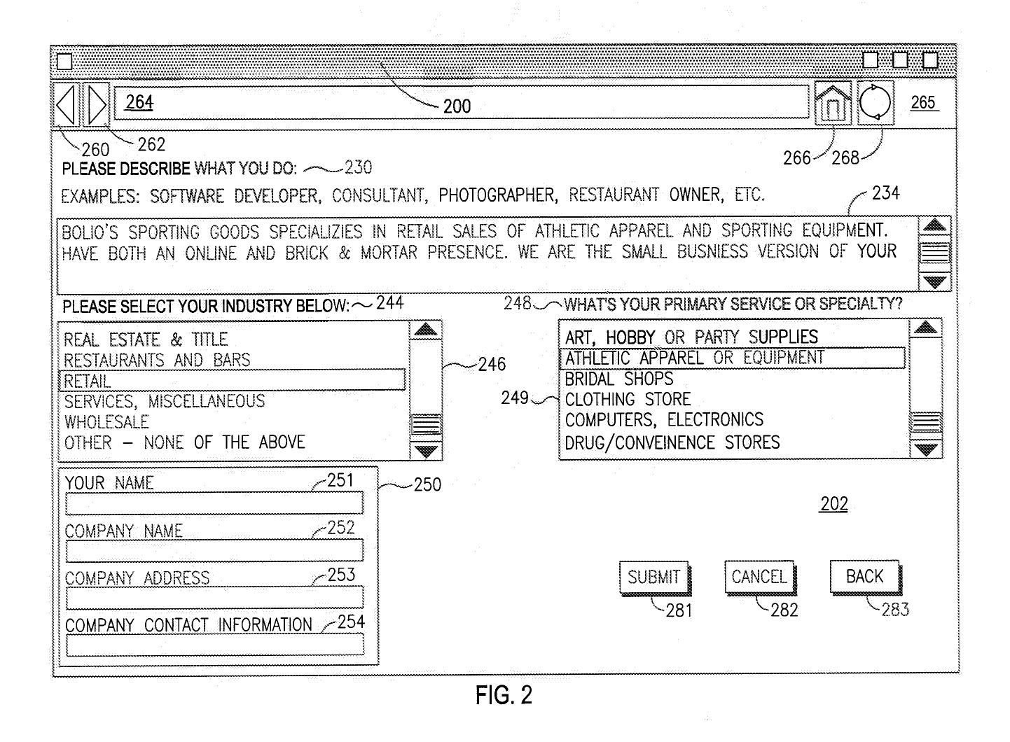

FIGS. 2-7 show example web pages that may be displayed by the web browser module 112. As will be described in detail below, the web pages may include display elements which prompt the user of the client device 110 for information about the user's business. The web pages may be included in a web browser window 200 that is displayed and managed by the web browser module 112. The web pages may include data received by the web browser module 112 from the web site system 120. The web pages may include information related to products sold by the insurance company, information related to clients that have purchased products sold by the insurance company, and other related information.

The web browser window 200 may include a control area 265 that includes a back button 260, forward button 262, address field 264, home button 266, and refresh button 268. The control area 265 may also include one or more additional control elements (not depicted). The user of the client device 110 may select the control elements 260, 262, 264, 266, 268 in the control area 265. The selection may be performed, for example, by the user clicking a mouse or providing input via keyboard, touch screen, and/or other type of input device. When one of the elements 260, 262, 264, 266, 268 is selected, the web browser module 112 may perform an action that corresponds to the selected element. For example, when the refresh button 268 is selected, the web browser module 112 may refresh the page currently viewed in the web browser window 200.

FIG. 2 shows an example web page that includes one or more questions that solicit information from a business owner related to their business. As shown in FIG. 2, the web page 202 may include a business description information area 230 and an industry information area 244 a specialty area 248, general information area 250.

The general information area 250 in the web page 202 includes input fields 251-254. The input field 251 prompts the user of the client device 110 for a text input identifying the name of the user of the client device 110. The input field 252 prompts the user of the client device for a text input identifying the company name for which insurance is sought. The input field 253 prompts the user for a text input identifying for the company address. The input field 254 prompts the user for a text input identifying for the company contact information (e.g. email, phone number).

The business description area 230 in the web page 202 may include an input field 234. The input field 234 prompts the user of the client device 110 for a text based description of the type of business for which the user of the client device 110 is seeking coverage. As shown in FIG. 2, the input field 234 shows an example question (e.g., “Please describe what you do?”) that solicits information from the user of the client device 110. The example question for input field 234 asks the user to enter in text form the type of industry with which the user's business is associated.

The industry information area 244 in the webpage 202 may include an input field 246. The input field 246 prompts the user of the client device 110 for a selection of the industry for which the user is seeking coverage. As shown in FIG. 2, the input field 246 shows an example question (e.g. “Please select your industry, below:”) that solicits information from the user of the client device 110. The example question for input field 246 asks the user to select one or more industries in the list presented in the input field 246.

The specialty area 248 in the webpage 202 may include an input field 249. The input field 249 prompts the user of the client device 110 for a selection of the primary service or specialty of the business for which the user is seeking coverage. As shown in FIG. 2, the input field 249 shows an example question, (e.g. “What's your primary service or specialty?”), that solicits information from the user of the client device 110. The example question for input field 249 asks the user to select one or more services or specialties in the list presented in the input field 249. Also shown is a submit button 281, cancel button 282 and back button 283.

In another embodiment, the user may skip the step of entering a text based description of the business. Instead the web browser module 112 may request access to a social network account associated with the business. The user of the client device 110 may then enter the social network information allowing the web browser module 112, the web site system 120 or a third party application to access information about the business based on the social media profile. The web browser module 112, the web site system 120 or a third party application may then download pictures and text available on the social media profile.

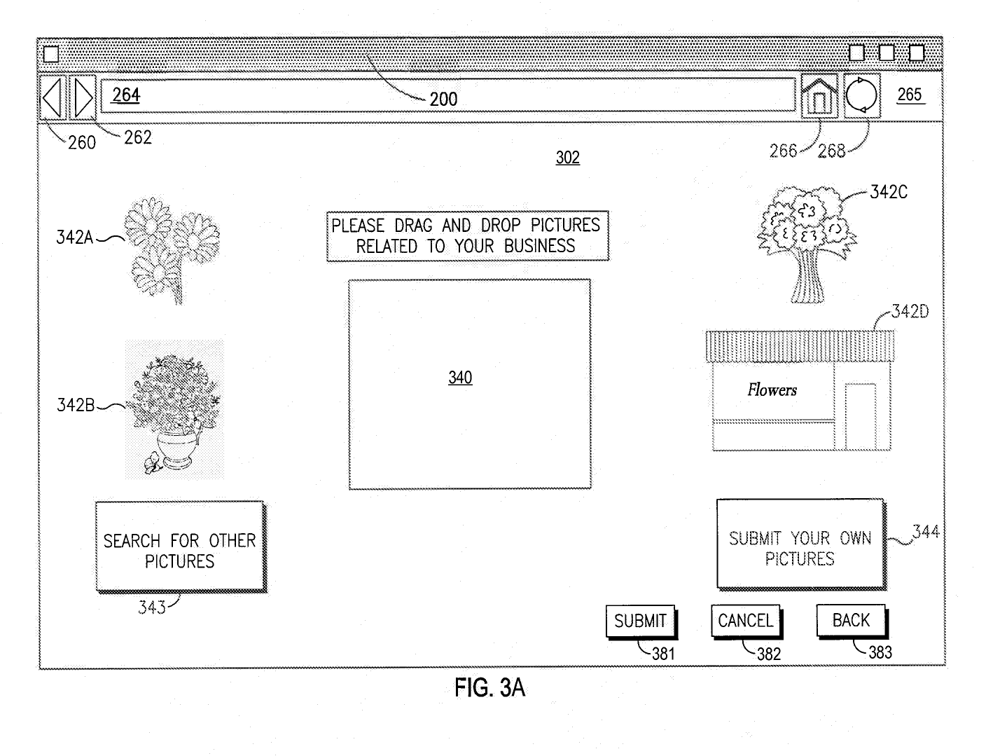

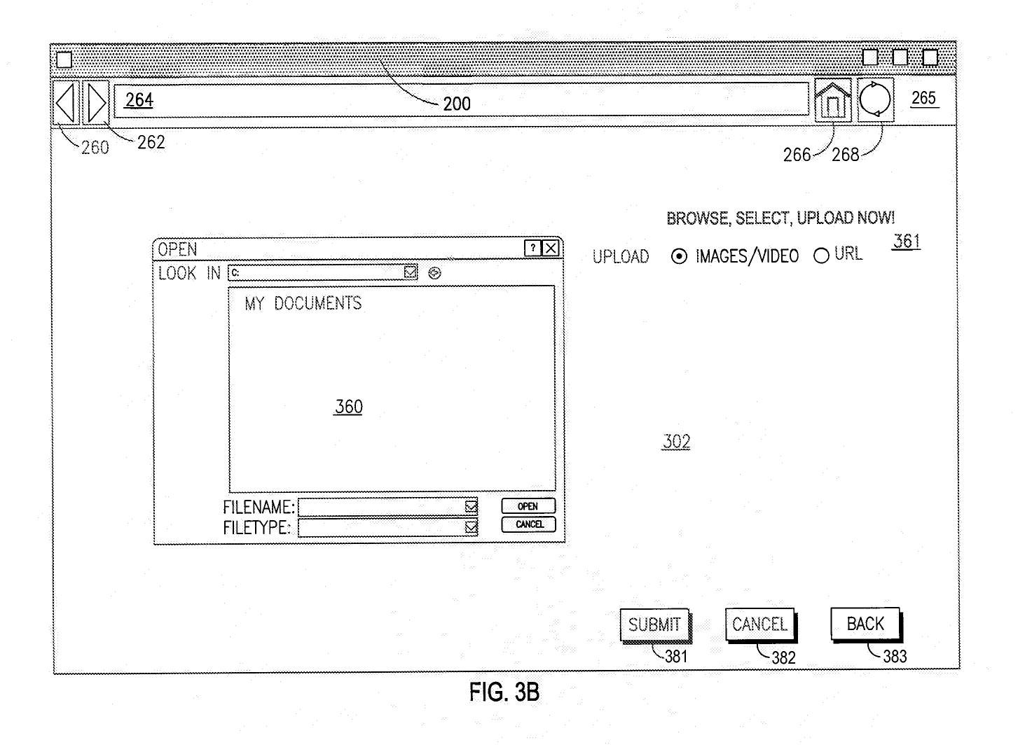

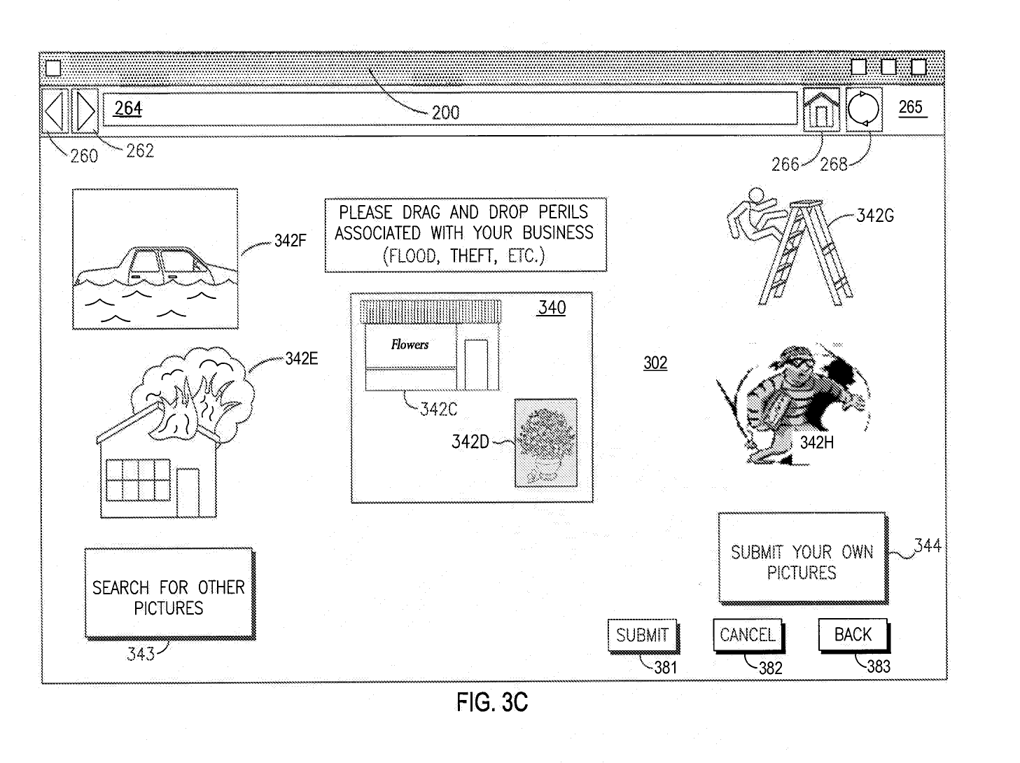

In another embodiment, the web browser module 112 may request the user of the client device 110 to enter an URL associated with the business for which insurance is sought. The web browser module 112 may then access the website using the URL and perform a search of the website for they business address, keywords associated with the business and pictures from the website. This may allow the user of the client device 110 to skip the step of manually entering text based information. The web browser module 112 may use this information to present the user of the client device 110 with pictures to select, as shown in FIG. 3A.

As will be described in further detail below, the user of the client device 110 may provide information that is responsive to the questions by selecting and entering information into the input fields 234, 246, 249, and 251-254. Also as will be described in further detail below, when the user of the client device 110 selects one of the input fields 234, 246, 249, and 251-254, additional display elements may be added to the input fields 234, 246, 249, and 251-254, via which the user may provide responsive information.

The web browser module 112 may store information that describes insurance products offered by the insurance company. These products may include, for example, property insurance, general liability insurance, commercial automobile insurance, workers' compensation insurance, captive insurance, commercial umbrella insurance, management and professional liability insurance, commercial marine insurance, employer-sponsored individual life insurance, and/or other products. The web browser module 112 may further store information that describes the relationship between the data that may be input into the input fields 234, 246, 249, and 251-254, and the insurance products. For example, the web browser module 112 may store information that indicates, for each option associated with a product, whether that option is appropriate or not for each of the types of information that may be input into the input fields 234, 246, 249, and 251-254. For example, the web browser module 112 may store information that indicates, for a particular option, to which industries the option is applicable.

As the user provides input into the input fields 234, 246, 249, and 251-254, the web browser module 112 may store one or more data structures (“question response data”) that reflect the selections made in the input fields 234, 246, 249, and 251-254.

FIG. 3A shows the web page 302 after the user has entered and submitted information from web page 202 of FIG. 2. As shown in FIG. 3, there is a picture input field. Based on the information from web page 202, the web browser module 112 provides the user of the client device 110 with a selection of pictures. In FIG. 3A, four example pictures are shown, pictures 342A-D, however, the number and types of images presented by web browser module 112 may vary. As shown in FIG. 3A, the user of the client device 110 is prompted to select pictures related to the user's business. The user of the client device 110 may select these pictures by dragging and dropping pictures that describe the user's business into picture selection area 340. If the user of the client device 110 has selected any of pictures 342A-D those selections will also be reflected in the update of the matching products area.

Alternatively or additionally, the user may select the Search for Other Pictures button 343. When the Search for Other Pictures 343 is selected, the web browser module 112 may determine another set of pictures to present to the user. This larger set of pictures may be determined based on the metadata tags associated with the pictures. The web browser module may then present a pop-up web page screen (not pictured) with additional pictures for the user to select. If the user of the client device 110 selects any additional pictures from the pop-up web page, web browser module 112 may update the picture selection area 340 with the selected pictures.

FIG. 3A shows an example wherein the user of the client device 110 has previously selected florist as their industry. Accordingly, the web browser module 112 displays on the client device 110 pictures related to florist-type businesses. The web browser module 112 may require a predetermined minimum number of pictures (for example, it may require at least three pictures to be selected). The actual number may vary depending on the type of business and the metadata requirements associated for the particular business. The web browser module 112 may prompt the user of the client device 110 to perform multiple iterations of selections to better identify the type of business for which insurance is sought.

Additionally, or alternatively, the web page module 112 may be configured to obtain “street-view” pictures based on the information provided in the general information area 250 in the web page 202. The web page module 112 may be configured to access through the Internet, street-view information from Google Maps or Apple Maps etc. The street view may further be embedded with metadata information based on the address and other information. This may include location information, it may include crime data statistics based on the location, etc. The user of the client device 110 may then be able to select a street-view picture of the business to enter into the picture selection area 340.

Alternatively or additionally, if the user arrives at the web site managed by the web site system 120 via a search engine, the pictures displayed in the web page 302 may be determined based on the search terms that were used to arrive at the web site system 120. For example, if the user had used a search term that relates to a given industry, the pictures displayed on web page 302 may include pictures often selected by other clients whose businesses are in the same given industry.

Additionally, the user of the client device 110 may select the Submit Your Own Pictures button 344. FIG. 3B shows an updated web page 302 after the user of the client device 110 has selected the Submit Your Own Pictures button 344. In response to the selection of this button, the web browser module 112 presents the user with an updated web page 302. The updated web page 302 includes radio buttons 361 for selecting the source of the input. As shown in FIG. 3B, if the user selects the radio button for uploading a file, dialogue box 360 appears. The user can select a picture stored in the memory of the client device 110 to upload. This picture may then be transmitted by the web browser module 112 to the web site system 120.

In one embodiment, if the client device 110 is a mobile device, the picture file that is uploaded may contain longitude and latitude information. This information may be stored and may be used to generate additional “street-view” or “store front” pictures for the user to select. This picture may then be transmitted by the web browser module 112 to the web site system 120.

Alternatively, the user can select the radio button 361 corresponding to URL and the user can submit a uniform resource locator (URL) of a picture available on the Internet. This picture may then be transmitted by the web browser module 112 to the web site system 120.

In one embodiment, the user of the client device 110 may skip earlier steps wherein text based information provided via the web browser module 112 and instead begin the process by submitting their own pictures.

Once the selected picture is then transmitted via the web browser module 112 to the web site system 120, the web site system 120 may perform an analysis on the picture with image recognition software. The image recognition software of the website system 120 may identify the contents of the image and assign metadata values to the picture. This information may be stored in the database 128.

FIG. 3C shows the web page 302 after the user of the client device 110 has selected two pictures related to the business and dragged them into the picture selection area 340. As shown in FIG. 3C, the web browser module 112 has updated the web page 302 to reflect the user's selections and added additional pictures that are related various types of perils that require coverage. As shown in FIG. 3C the web browser module 112 has provided the user with pictures 342E-342H which show a fire, a flood, a work place injury, and theft, respectively. The web browser module 112 may continue to update web page 302 to include additional pictures based on the selected pictures.

Although the web page 302 of FIGS. 3A-3C shows a set number of input pictures, any number of pictures, thumbnails, or drawings may be used in the product. Further the number of pictures may vary based on the client device 110 device being used. Additionally, while specific display elements are described above as used for receiving user input data (e.g., the radio buttons and input fields), any combination of the above-described types of display elements and/or other types of display elements may be used for receiving user input data. Also shown is a submit button 381, cancel button 382 and back button 383.

Table 1 shows an example entry in a database of metadata that may be associated with each picture. As shown in the table, each file may have multiple metadata tags for each field. Some fields may be left blank if it is not applicable to the picture.

| | File | File | | Liability | UW | | Suggested |
|---|---|---|---|---|---|---|---|
| # | Name | Type | Industry | Code | Questions | . . . | Coverages |
| 1 | Flower | JPG | Florist | 32606 | Do you | . . . | Fire |
| | | | Nursery | 32605 | sell any | | Break-in |
| | | | | | poisonous | | Flooding |
| | | | | | plants? | | |
| . . . | . . . | . . . | . . . | . . . | . . . | . . . | . . . |
| n | Pizza | TIF | Restaurant | 5220 | Do you | . . . | Auto |
| | Deliv- | | | | perform | | Fire |
| | ery | | | | back- | | |
| | | | | | ground | | |
| | | | | | checks on | | |
| | | | | | your | | |
| | | | | | drivers? | | |

Referring back to FIG. 3C, the submit button 381 may be selected by the user of the client device 110. In response to the selection, the web browser module 112 may transmit the question response data (which may be based on user input, as described above) to the web site system 120. This may include, for example, the web browser module 112 transmitting information related to the question response data to the HTTP server module 124. For example, the web browser module 112 may send one or more HTTP GET or POST messages to the HTTP server module 124 that include one or more parameters that also include the question response data. The HTTP server module 124 may then provide the question response data to the results module 114.

The results module 114 receives the transmitted information and may identify the metadata associated with the pictures. Based on the metadata, the results module 114 may apply a software based algorithm to determine a business classification and risk profile of the business to be insured (e.g. NBV/ICON classification). For example, the metadata from the selected pictures may be used to determine the line of business (LOB), the class code, the associated class code, a general liability code, and the class description associated with the business. As noted above, each picture may have multiple metadata tags for each field, accordingly, the results module may use a software algorithm to combine all of the available metadata from all of the selected pictures to determine a business classification and risk profile. For example, the web site system 120 may receive a selection of six (6) pictures. Each of the six pictures may include two or more entries in the “industry” field. The results module 114 is configured to mathematically determine the intersection of each of the industries associated with the pictures (in a manner similar to a Venn diagram) and determine a best fit industry based on the intersections. Additionally, the results module may be configured to correlate the selected pictures with historical selections of other users in a similar or related industry to determine a business classification and risk profile. The web site system 120 may be configured perform a similar operation on other metadata fields and determine a business classification.

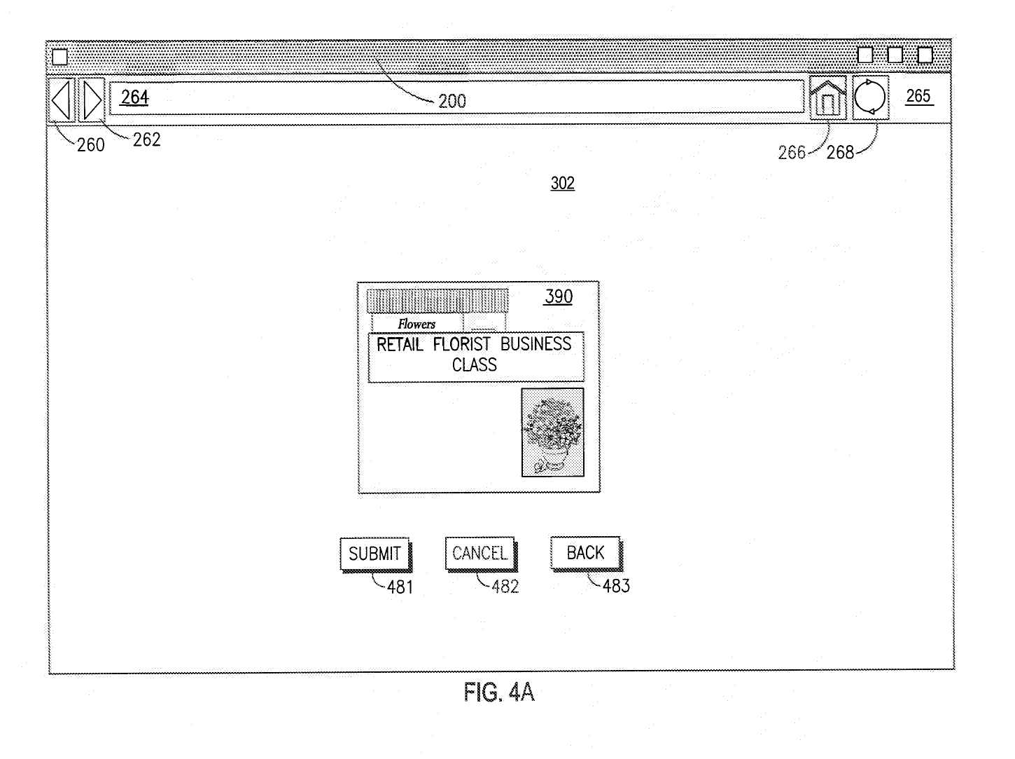

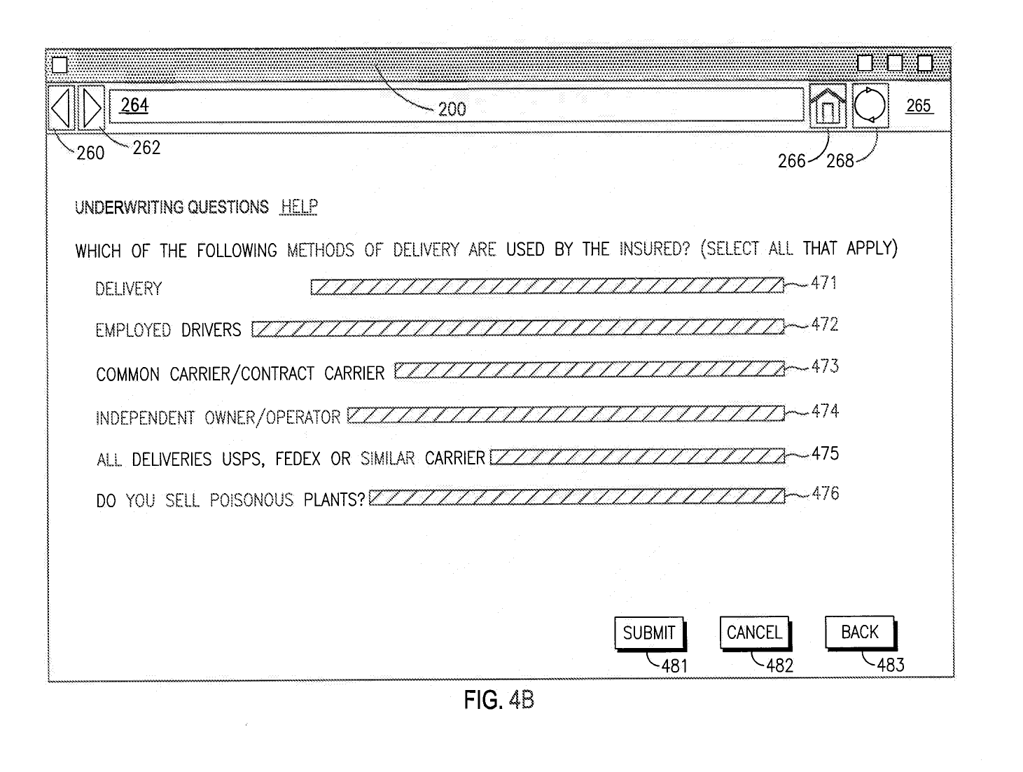

FIG. 4A shows an example business classification results web page 302 presented to the user of the client device 110. Based on the selected pictures and the associated metadata, the web site system 120 has determined that the business is a retail florist business and is within a classification of business for which the insurance company offers coverage. The user of the client device 110 is provided with a classification result 390.

If the user does not agree with classification result 390, the user can select the cancel button 482 or back button 483. This notifies the results module 114 that the classification result was not accepted by the user of the client device 110. In response to the selection of the cancel button 482 or back button 483 the web site system 120 may be configured to provide the client device 110 with revised versions of the previously presented web pages. For example, the web site system 120 may transmit to the user of the client device 110 an additional web page that includes one or more questions that solicit additional information from a business owner related to their business. Alternatively the web site system 120 may transmit a web page with additional pictures and prompt the user to select from the additional pictures. The results module 114 may also be configured to revise the metadata and algorithm based on these selections to refine the automated classification process.

If the user agrees with the classification result 390, the user of the client device 110 can select the submit button 381, in which case the information is submitted to the web site system 120 as described above in connection with FIG. 3C. When the user selects submit button 381, the website system 120 confirms that the business classification was accurate. The results module 114 may then access the underwriting questions metadata associated with the user's selections and then present the user with additional questions on the client device 110.

FIG. 4B shows an example web page that includes one or more underwriting questions that solicit information from a business owner related to their business. As shown in FIG. 4B there are multiple underwriting questions along with associated input fields 471-476. The input fields 471-476 prompt the user of the client device 110 for a text input responsive to the associated questions. The results module 114 generates these underwriting questions to refine the business classification and risk profile. These questions may be generated based on the underwriting questions metadata associated with each picture, underwriting questions based on the determined business classification, and/or predetermined underwriting questions stored in the database 128.

Once the user input answers responsive to the questions into input fields 471-476, via the client device 110, the user of the client device 110 may select the submit button 481. When the user selects submit button 481, the web site system 120 may then contact an agent device 111. The agent device 111 may be prompted to contact the requester using the company contact information 254. The web browser module 113 also presents the user of the agent device 111 with information generated by the results module 114.

The results module 114 may then determine a set of insurance products and options associated with the insurance products that match the classification and risk profile. Further, the results module 114 may rank the products and options in terms of relevance to the user, based on the question response data. Additionally, the results module 114 may determine how a results web page that includes information related to the products should appear, based on the question response data. This may include, for example, determining how information related to the products should be formatted based on their rank and/or relevance to the user. The results module 114, in conjunction with the HTTP server module 124 and/or the CMS 126, may then generate information that describe a results web page, and send the information to web browser module 112 in the client device 110 using an HTTP response that is responsive to the receive HTTP GET or POST messages described above.

In addition to the question response data, the web browser module 112 may obtain data obtained directly from other modules (not depicted). For example, the web browser module 112 may obtain data from modules in the client device 110, without input from the user of the client device 110. This may include, for example, location information that may be obtained from a Global Positioning System (GPS) module (not depicted) in the client device 110, and/or other data. This additional information may be transmitted by the web browser module 112 along with the question response data that is sent to the results module 114. The results module 114 may use this additional data in determining whether a product is available to a user, determining product relevance, and/or determining how the results web page that includes the information related to the products should appear. Alternatively or additionally, the web browser module 112 may access a social media profile associated with the business to obtain data.

Alternatively or additionally, if the user selects an industry or event that is not within the insurance businesses policy, the user may be presented with an alternate web page indicating that there are no products available. In some cases, this may prompt the user to select the back button 483 and modify the selections. For example, if the user selects the back button 483, they may be presented with a web page similar to FIG. 3C. The user of the client device 110 may then cancel a selection of a flood picture, such as 342F and replace the picture with the fire picture 342E. After the user of the client device 110 has modified the selections, they may submit the selection to the web site system 120 by selecting the submit button 481.

The web site system 120 is further configured to identify and track any changes in selections. This may be performed, for example based on a user profile created when the general business information is submitted and/or by logging the IP Address of the client device 110. Any changes to picture selections may be flagged by the web site system 120 and transmitted to the user of an agent device 111 to prevent a user of a client device 110 from “gaming the system” to receive a quote for a type of business or event that is not within the insurers business model.

The information generated by the results module 114 may identify all of the metadata information identified from the selected pictures, company details, suggested insurance products that match the selections.

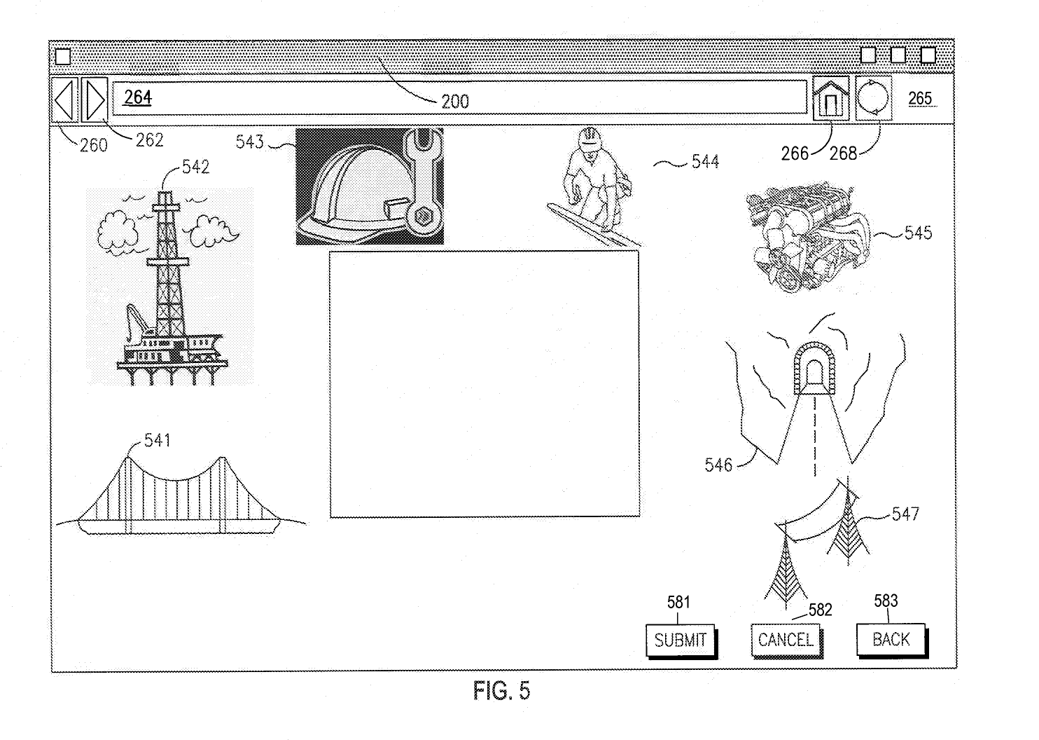

FIG. 5 shows an example web page after the user has entered and submitted information from web page 202 of FIG. 2. In this scenario, the user of the client device has selecting engineering as the relevant industry. As shown in FIG. 5, the user of the client device 110 is presented pictures 541-547. Each picture represents different aspects of engineering and contains different associated metadata. For example, picture 541 may be related to civil engineering, picture 542 to petroleum engineering, pictures 543 and 544 to subcontracting, picture 545 to heavy machinery, picture 546 to tunnel building, and picture 547 to power engineering. Each may be tagged with a corporate appetite field, which may indicate the willingness of the insurer to offer coverage for an activity. For example, if a user selects picture 547, the corporate appetite metadata may immediately indicate to the results module 114 this is an activity not covered by the insurance company. On the other hand, if the user selects picture 542, it may indicate to the results module 114 that this is an activity that is likely to be covered by the insurance company. Also shown is a submit button 581, cancel button 582 and back button 583.

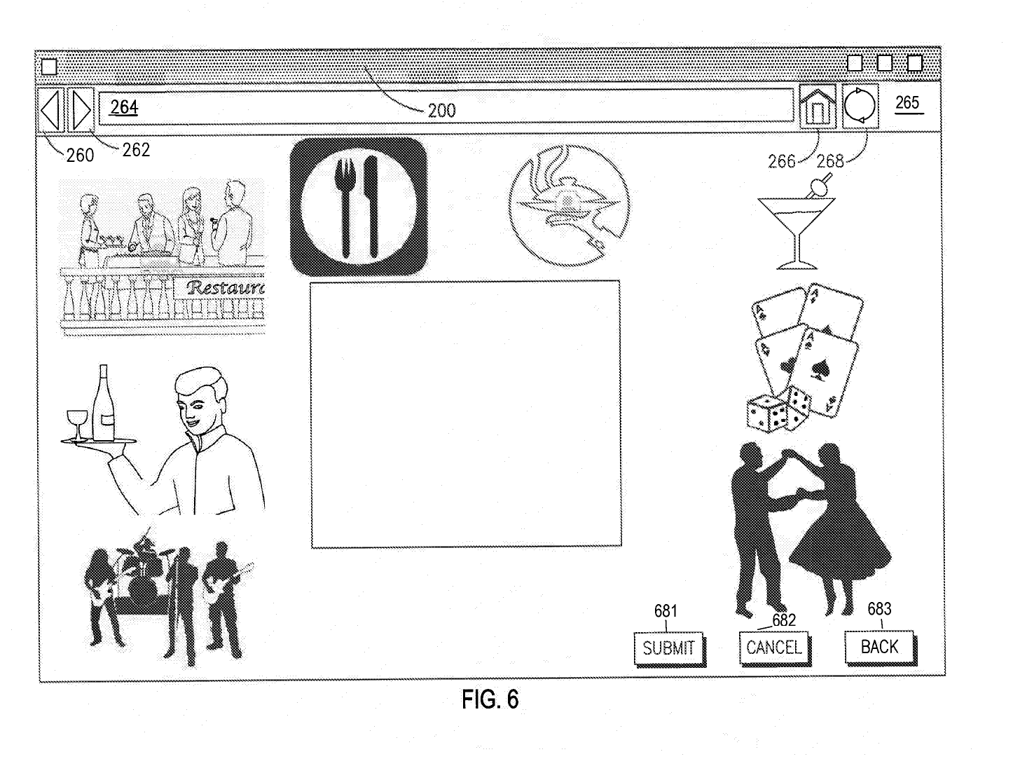

FIG. 6 shows an example web page after the user has entered and submitted information from web page 202 of FIG. 2. In this scenario, the user of the client device 110 has selected the restaurant/food service as the associated industry. As described above, each picture may have different metadata associated with it. The metadata associated with the pictures may generate a business classification and risk profile to assist in the underwriting process. In one example, a user selecting a picture with a live band may indicate to the results module 114 that the restaurant is not in a classification that is covered by the insurance company. Alternatively, it may indicate that it is covered by the insurance company but an additional premium is required. Also shown is a submit button 681, cancel button 682 and back button 683.

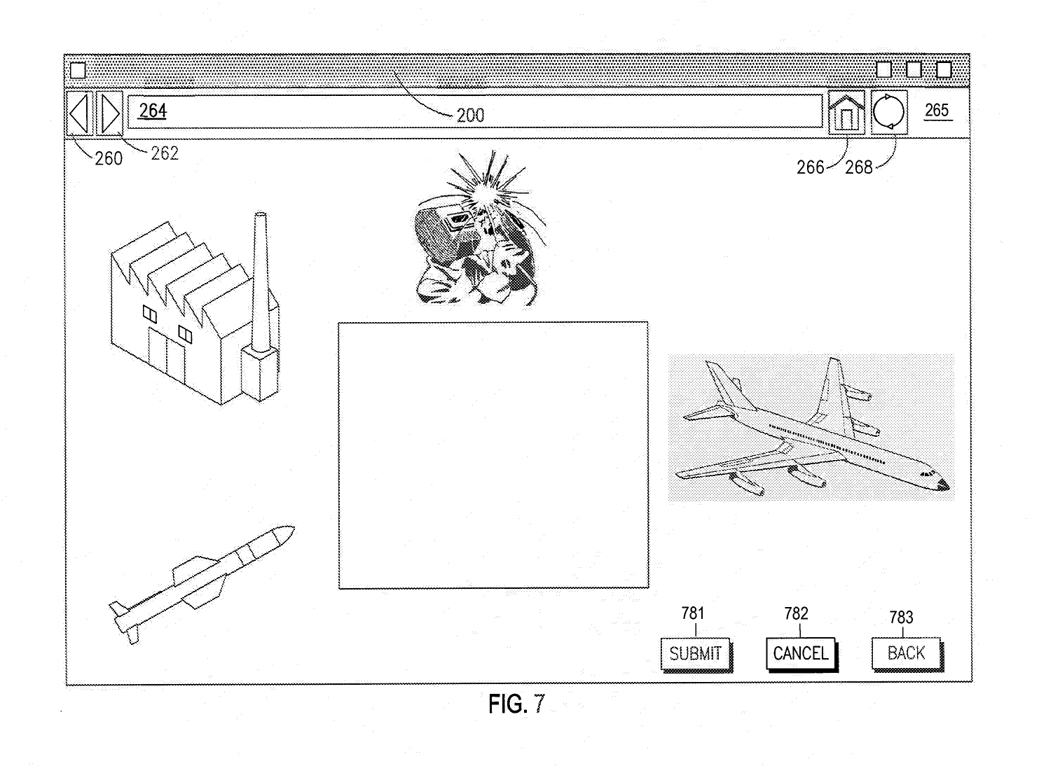

FIG. 7 shows an example web page after the user has entered and submitted information from web page 202 of FIG. 2. In this scenario, the user may have selected manufacturing as the associated industry. As described above, each picture may have different metadata associated with it. The metadata associated with the pictures may generate a business classification and risk profile to assist in the underwriting process. In one example, a user selecting a picture with a missile may indicate to the results module 114 that the business is related to the manufacturing of missiles and it is not in a classification that is covered by the insurance company. Alternatively, it may indicate that it is covered by the insurance company but an additional premium is required. Also shown is a submit button 781, cancel button 782 and back button 783.

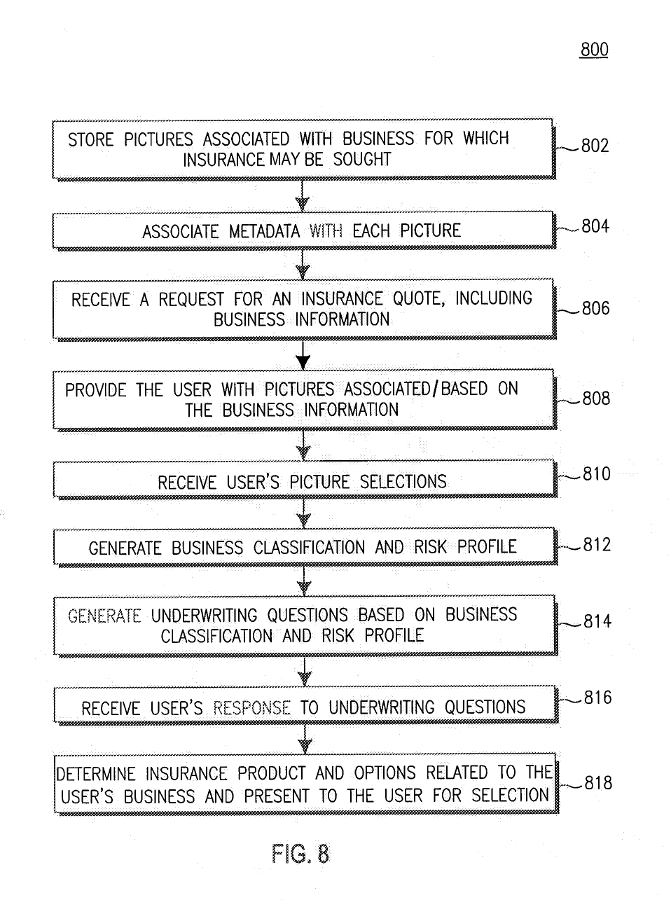

FIG. 8 shows an example method 800 for obtaining and processing information related to business insurance products. The method 800 of FIG. 8 may begin with storing pictures associated with businesses for which insurance may be sought (step 802). Next metadata is associated with each picture (step 804). This metadata may be stored in a database 128 associated with a web site system 120.

A user of client device 110 may require insurance information. The user may then access the web site system using a client device 110 and submit a request for an insurance quote. This may be performed, for example by entering preliminary business details relating to the business to be insured (e.g. type of business, address of business.) This information may be responsive to questions included on the web site. The request may be received via one or more input devices, such as a keyboard, a mouse, a trackball, a touch screen, a touch pad, a stylus pad, and/or other input device. The user may then use a client device 110 to electronically submit a request for an insurance quote (step 806).

Next, based on the business information electronically transmitted by the client device 110, the web site system 120 determines a set of pictures to present to the user. The user may then be prompted to select pictures that are associated with the business for which insurance is sought (step 808). The user selects pictures and the user's selections are received by the web site system (step 810). The picture selection may be received via one or more input devices, such as a keyboard, a mouse, a trackball, a touch screen, a touch pad, a stylus pad, and/or other input device. Steps 808 and 810 may be repeated for multiple iterations offering different pictures to assist the web site system 120 in creating a more complete profile of the business.

Once the user of the client device 110 has completed the process of transmitting picture selections, the web site system 120 then uses a software program to generate a business classification and risk profile (step 812).

The results module 114 then generates underwriting questions based on the business classification and risk profile. (Step 814). The web site system receives the user's responses to the underwriting questions. (Step 816).

Once the results module 114 has received the response to the underwriting questions, the results module 114 determines an insurance product and associated options which may be related and other information relevant to generating a price quote. The software program determines this information based on the metadata associated with user's picture selections and the response to the underwriting questions. Information regarding the relevant product and associated options may then be displayed via one or more display devices (step 818).

FIG. 9 shows an example computing device 910 that may be used to implement features described above with reference to FIGS. 1-8. The computing device 910 may include a processor 918, memory device 920, communication interface 922, input device interface 912, display device interface 914, and storage device 916. FIG. 9 also shows a display device 924, which may be coupled to or included within the computing device 910.

The memory device 920 may be or include a device such as a Dynamic Random Access Memory (D-RAM), Static RAM (S-RAM), or other RAM or a flash memory. The storage device 916 may be or include a hard disk, a magneto-optical medium, an optical medium such as a CD-ROM, a digital versatile disk (DVDs), or Blu-Ray disc (BD), or other type of device for electronic data storage.

The communication interface 922 may be, for example, a communications port, a wired transceiver, a wireless transceiver, and/or a network card. The communication interface 922 may be capable of communicating using technologies such as Ethernet, fiber optics, microwave, xDSL (Digital Subscriber Line), Wireless Local Area Network (WLAN) technology, wireless cellular technology, and/or any other appropriate technology.

The input device interface 912 may be an interface configured to receive input from an input device such as a keyboard, a mouse, a trackball, a touch screen, a touch pad, a stylus pad, and/or other device. The input device interface 912 may operate using a technology such as Universal Serial Bus (USB), PS/2, Bluetooth, infrared, and/or other appropriate technology.

The display device interface 914 may be an interface configured to communicate data to display device 924. The display device 924 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 914 may operate using technology such as Video Graphics Array (VGA), Super VGA (S-VGA), Digital Visual Interface (DVI), High-Definition Multimedia Interface (HDMI), or other appropriate technology. The display device interface 914 may communicate display data from the processor 918 to the display device 924 for display by the display device 924. As shown in FIG. 9, the display device 924 may be external to the computing device 910, and coupled to the computing device 910 via the display device interface 914. Alternatively, the display device 924 may be included in the computing device 910.

An instance of the computing device 910 of FIG. 9 may be configured to perform any feature or any combination of features described above as performed by the client device 110. In such an instance, the memory device 920 and/or the storage device 916 may store instructions which, when executed by the processor 918, cause the processor 918 to perform any feature or any combination of features described above as performed by the web browser module 112. In such an instance, the computing device 910 may be, for example, a laptop computer, a tablet computer, a desktop computer, cellular phone (such as but not limited to the cellular phone 1000 described below with reference to FIG. 10), a personal digital assistant (PDA), or any other appropriate computing device.

Alternatively or additionally, an instance of the computing device 910 may be configured to perform any feature or any combination of features described above as performed by the quoting/binding module 122, HTTP service module 124, CMS 126, and/or results module 114. In such an instance, the memory device 920 and/or the storage device 916 may store instructions which, when executed by the processor 918, cause the processor 918 to perform any feature or any combination of features described above as performed by the quoting/binding module 122, HTTP service module 124, CMS 126, and/or results module 114. In such an instance, the computing device 910 may be a server computer or any other appropriate computing device.

Further, an instance of the computing device 910 may be configured to perform any features or combination of features described above as performed by the policy management system 104. In such an instance, the memory device 920 and/or the storage device 916 may store instructions which, when executed by the processor 918, cause the processor 918 to perform any feature or any combination of features described above as performed by the policy management system 104. In such an instance, the computing device 910 may be a server computer or any other appropriate computing device.

FIG. 10 shows a cellular phone 1000 that is a more specific example of the computing device 910 described above with reference to FIG. 9. The cellular phone may include a touch screen 1024, and may also include a processor (not depicted), memory device (not depicted), communication interface (not depicted), input device interface (not depicted), display device interface (not depicted), and storage device (not depicted), which may possess characteristics of processor 918, memory device 920, communication interface 922, input device interface 912, display device interface 914, and storage device 916 described above with reference to FIG. 9. The touch screen 1024 is a more specific example of the display device 924 described above with reference to FIG. 9, and may be based on technology such as, for example, LCD, LED, and/or other appropriate display technology. The touch screen 1024 may receive user input using technology such as, for example, resistive sensing technology, capacitive sensing technology, optical sensing technology, or any other appropriate touch-sensing technology. The touch screen 1024 may provide user input data to the input device interface (not depicted) in the cellular phone 1000. The communication interface (not depicted) in the cellular phone may be a wireless transceiver, and may be capable of communicating using wireless technology such as Long Term Evolution (LTE), LTE-Advanced (LTE-A), Universal Mobile Telecommunications System (UMTS), IEEE Institute of Electrical and Electronics Engineers (IEEE) 802.16/WiMax, IEEE 802.16m, Wireless Broadband (WiBro), Global System for Mobile Communications (GSM), Enhanced Data Rates for GSM Evolution (EDGE) Radio Access Network (GERAN), Code Division Multiple Access 2000 (CDMA2000), and/or any other appropriate wireless technology.

The touch screen 1024, as shown in FIG. 10, may display the questions and results described in accordance with the methods described above. As described above with reference to FIG. 9, the processor in the cellular phone 1000 may execute instructions which cause the processor to perform the functionality described above as performed by the web browser module 112. The touch screen 1024 may be configured to show the pictures as thumbnails which may be expanded upon selection for review. Alternatively, the touch screen 1024 may be configured to display the pictures in a slide show format allowing the user to view each of them. The web site system 120 may be configured to identify that the client device 110 is a mobile phone and may prompt the user of the client device 110 to take a photogram with the mobile phone and upload it to the website system 120.

Although examples are provided above with reference to FIGS. 1-7 wherein data is communicated between a web site system 120 and a web browser module 122, the features described above as performed by the web site system 120 and/or the web browser module 122 may be implemented in any combination of software and/or hardware. For example, the features described above as performed by the web browser module 122 and/or the web site system 120 may be performed, mutatis mutandis, by one or more dedicated or special-purpose applications.

Although examples are provided above with respect to businesses, business owners, and business insurance products, the features describe above with reference to FIGS. 1-10 are equally applicable, mutatis mutandis, to other contexts. For example, the features described above may be used for the communication of information related to and/or the selection of insurance products that are applicable to all types of insurance consumers, including individuals, businesses, non-profit entities, governmental entities, and/or any other types of insurance consumers. For example, the features described above may be used for communication of information related to and/or the selection of individual insurance products, and/or any other insurance products. Alternatively or additionally, the features described above may be used for the communication of information related to and/or the selection of financial products that are not insurance products, such as risk management services, bonds, retirement plans, savings plans, and/or group benefits plans.

Although examples are provided above with respect to a client device 110, all the methods described herein may be performed by the agent device 111 or another type of user device.

When referred to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or BD, or other device for electronic data storage.

As used herein, the term “picture” broadly refers to and is not limited to any particular type of visual electronic format, including photographs, video, renderings, drawings and other visual electronic formats,

As used herein, the term “processor” broadly refers to and is not limited to a single- or multi-core general purpose processor, a special purpose processor, a conventional processor, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Although features and elements are described above in particular combinations, each feature or element can be used alone or in any combination with the other features and elements. For example, each feature or element described above with reference to any one or any combination of FIGS. 1-10 may be used alone without the other features and elements or in various combinations with or without other features and elements described above with reference to any one or any combination of FIGS. 1-10. Sub-elements of the methods and features described above may be performed in any arbitrary order (including concurrently), in any combination or sub-combination.

1. A system for the processing and display of information related to business insurance options offered by an insurance company, the system comprising:
a memory device configured to store a plurality of pictures related to at least one business insurance product, metadata associated with the pictures, and information related to the at least one business insurance product;
a transmitter configured to transmit display information, the display information including questions related to general information about a business;
a receiver configured to receive input data from a user device that is responsive to the questions;
a processor configured to determine a set of pictures from the plurality of pictures based on the received input data responsive to the questions;
a communication device associated with the processor configured to transmit the set of pictures to a user device;
the receiver further configured to receive input data from the user device, wherein the input data indicates selections of a subset of the set of pictures; and
the processor further configured to determine a business classification, based on metadata associated with the selected subset of the set of pictures.

2. The system of claim 1, wherein the communication device is further configured to transmit the determined business classification to the user device.

3. The system of claim 2, wherein the receiver is further configured to receive confirmation data, from the user device, in response to the transmitted business classification.

4. The system of claim 1, wherein the processor is further configured to generate underwriting questions based on the metadata associated with the selected subset of pictures.

5. The system of claim 4, wherein the processor is further configured to determine an insurance product and associated options to offer the user, based on the metadata associated with the selected subset of pictures and the response to the underwriting questions.

6. The system of claim 1, wherein the metadata includes at least one of the following fields:
a. picture number or filename;
b. picture file type;
c. industry;
d. liability code associated with the industry;
e. worker's compensation codes associated with the activity/industry;
f. commercial automobile codes;
g. underwriting/class questions;
h. corporate appetite for coverage of industry/activity; and
i. recommended coverages.

7. The system of claim 6, wherein the processor is configured to compare at least the industry metadata field and to perform an analysis to determine a best fit business classification.

8. The system of claim 1, wherein the receiver is further configured to receive a picture uploaded from the user device and to store it in the memory device.

9. The system of claim 8, wherein the processor is configured to generate metadata associated with the uploaded picture.

10. A method for the processing and display of information related to business insurance options offered by an insurance company, the method comprising:
storing, by a memory device, pictures related to at least one business insurance product, metadata associated with the pictures, and information related to the at least one business insurance product;
transmitting, by a transmitter, display information, the display information including questions related to general information about a business;
receiving, by a receiver, input data from a user device that is responsive to the questions;
determining, by a processor, a set of pictures from the plurality of pictures based on the received input data;
transmitting, by a communication device, the set of pictures to the user device;
receiving, by the receiver, input data from the user device, wherein the input data indicates selections of a subset of the set of pictures; and
determining, by the processor, a business classification, based on metadata associated with the selected subset of pictures.

11. The method of claim 10, further comprising transmitting the determined business classification to a user device.

12. The method of claim 11, further comprising receiving confirmation data, from the user device, in response to the transmitted business classification.

13. The method of claim 10, further comprising generating underwriting questions based on the metadata associated with the selected subset of pictures.

14. The method of claim 13, further comprising determining an insurance product and associated options to offer the user, based on the metadata associated with the selected subset of pictures and the input data to the underwriting questions.

15. The method of claim 10, wherein the metadata includes at least one of the following fields:
j. picture number or filename;
k. picture file type;
l. industry;
m. liability code associated with the industry;
n. worker's compensation codes associated with the activity/industry;
o. commercial automobile codes;
p. underwriting/class questions;
q. corporate appetite for coverage of industry/activity; and
r. recommended coverages.

16. The method of claim 15, further comprising comparing at least the industry metadata field and to perform an analysis to determine a best fit business classification.

17. The method of claim 10, further comprising receiving a picture uploaded from the user device and to store it in the memory device.

18. The method of claim 17, further comprising generating metadata associated with the uploaded picture.

19. A non-transitory computer-readable medium having processor-executable instructions stored thereon which, when executed by at least one processor, will cause the at least one processor to perform a method for the processing and display of information related to business insurance products offered by an insurance company, the method comprising:
storing, by a memory device, pictures related to at least one business insurance product, metadata associated with the pictures, and information related to the at least one business insurance product;
transmitting display information, the display information including questions related to general information about a business;
receiving input data from a user device that is responsive to the questions;
determining a set of pictures from the plurality of pictures based on the received input data;
transmitting the set of pictures to the user device;
receiving input data from the user device, wherein the input data indicates selections of a subset of the set of pictures; and
determining a business classification, based on metadata associated with the selected subset of pictures.

20. The non-transitory computer-readable medium of claim 19, further comprising transmitting the determined business classification to a user device.
